(19) United States
(12) Patent Application Publication
(10) Pub. No.: US 2023/0191751 A1
(43) Pub. Date: Jun. 22, 2023

(54) Metal Polymer Laminate Structure

(71) Applicant: BASF SE, Ludwigshafen am Rhein (DE)

(72) Inventors: Roman BEM, Ludwigshafen (DE); Patrick SPIES, Ludwigshafen (DE); Alexander LORENZ, Sinzheim (DE); Rolf HENN, Oftersheim (DE)

(21) Appl. No.: 17/999,176

(22) PCT Filed: May 17, 2021
(86) PCT No.: PCT/EP2021/063013

§ 371 Date: Nov. 17, 2022

(30) Foreign Application Priority Data
May 19, 2020 (EP) 20175450.4

(51) Int. Cl. B32B 15/088; B32B 15/095; B32B 15/08; B32B 27/34; B32B 27/30; B32B 27/40; B32B 27/32; B32B 27/36; B32B 27/28; B32B 27/18; B32B 5/18; B32B 38/12; A62C 2/06; B32B 37/18; B32B 37/10; H01M 10/658; C01B 32/225

(52) U.S. Cl. CPC B32B 15/088; B32B 15/095; B32B 15/08; B32B 27/34; B32B 27/304; B32B 27/40; B32B 27/32; B32B 27/36; B32B 27/306; B32B 27/285; B32B 27/308; B32B 27/18; B32B 5/18; B32B 38/12; A62C 2/065; B32B 37/182; B32B 37/1045; H01M 10/658; C01B 32/225; B32B 2274/00; B32B 2307/72; B32B 15/18

(57) ABSTRACT

Disclosed herein are a metal-polymer laminate structure having an enhanced flame protection function as well as a method for preparing the same. The metal-polymer laminate structure includes a metallic layer, at least one polymeric layer provided on the metallic layer, and a backing layer provided on the at least one polymeric layer. The at least one polymeric layer includes an intumescent material, and a first functional layer is interposed between the metallic layer and the at least one polymeric layer. The first functional layer is a thermoplastic layer constructed from a material selected from polyamide, thermoplastic polyurethane, hotmelts, preferably polyamides such as PA6, PA6/6.36, PA6/66, PA12, PA6.12, PA6.10, PA6I/6T, copolymers of caprolactam or lauryllactam, thermoplastic polyurethane, and polyether block co-polyamides or combinations thereof.

The present invention relates to a metal-polymer laminate structure as well as a method for preparing the same, wherein the metal-polymer laminate structure has an enhanced flame protection function.

For the construction of (electric) vehicle elements, for instance in marine, rail road and general public and personal transportation, usually monolithic metals are used. These metals are processed with known/typical methods like deep drawing, bending, stamping, die casting and the like.

Within such vehicles, functional components like batteries, electronic components and engines are particular sources of high thermal energy and therefore require in normal operating mode a high thermal conductivity of their housing material. Thus, metals are made the best material of choice. However, in exceptional cases these parts can act as source of fire whereby severe problems can occur. The high thermal conductivity of metallic housings can result in a fast spread of fire. Lightweight metals like aluminium, magnesium and/or zinc can melt, burn-through or even burn after direct contact to a flame. Accordingly, the construction metals according to the state of the art do not provide a sufficient flame protection. There is a need for a housing material which can ensure a sufficient flame protection for triggered heat isolation as well as an active burn-through protection.

In the state of the art several attempts have been described for such materials. For instance, WO 2019/155713 A1 describes a thermal insulation material which is arranged between the cells of a battery stack to compensate a thermal runaway reaction.

According to In EP 3 312 931 A1 a battery module comprises a plurality of isolating plates, each isolating plate is interposed between two adjacent mono-batteries, each isolating plate is provided with a through hole penetrating along the arrangement direction. Each isolating plate is configured to be capable of self-foaming to make a vol.

of each isolating plate expanded when each isolating plate is heated and a temp. of each isolating plate is more than 200° C.

JP 2017/130320 A relates in view of a battery stack to a thermal expansion material which is disposed in a gap between the electrode body and the current collecting terminal in the overlapped portion, and the temperature inside the battery case rises and the thermal expansion material expands.

WO 2015/113133 A1 discloses a battery housing having a body and a lid mateable with the body. The body and the lid, when mated, provide a chamber dimensioned to hold at least one battery; and a venting passageway from the chamber. At least a portion of at least one of the body and the lid comprises an intumescent flame retardant material with an expansion ratio sufficient to drive gas from the chamber through the venting passageway and to seal the chamber when the material intumesces in the event of thermal runaway of a battery housed in the chamber.

According to JP 2006/187891 A laminates comprise porous substrates of a 1^{st} plastic and on at least one side of the substrate's porous shutdown layers of a 2^{nd} plastic containing blowing agents that expand above a certain temperature, wherein the softening temperature of the 2^{nd} plastic is lower than that of the 1^{st} plastic. The laminates achieve immediate shut-down when batteries are overheated by their expansion and blocking of the separator pores.

EP 3 187 549 B1 relates to a thermally expandable fire-resistant resin composition, in particular a thermally expandable rigid foam compositions with expanded graphite. This prior art addresses the problem of the lack of mechanical stability of polymer formulation containing expanded graphite after its expansion (in case of fire). The inventors were able to achieve the effects by a special polymer composition and a particular expanded graphite. The polymer parts obtained exhibited a little more stability after expansion. This prior art offers compressive strengths of the polymer parts after pyrolysis at 600° C. A finger feeling tester was used for determination. However, the polymer parts were not exposed to direct flame treatment.

It is the aim of the present invention to provide an advanced metal-polymer laminate structure as well as a method for manufacturing the same, which exhibit enhanced flame protection while at the same time ensuring a lightweight structure.

The above-mentioned task is solved in first aspect of the present invention by a metal-polymer laminate structure (1), comprising
a metallic layer (101),
at least one polymeric layer (103) provided on the metallic layer (101) and
a backing layer (105) provided on the at least one polymeric layer (103),

wherein the at least one polymeric layer (103) comprises an intumescent material.

In addition, the above-mentioned task is solved in second aspect of the present invention by a method for preparing a metal-polymer laminate structure (1), in particular as detailed above, comprising the steps of
a) providing a metallic layer (101),
b) providing at least one polymeric layer (103) onto the metallic layer (101),
c) providing a backing layer (105) onto the at least one polymeric layer (103), thereby attaining a pre-laminate structure,
d) pressing the pre-laminate structure at elevated temperature and
e) obtaining the metal-polymer laminate structure (1).

Further, the above-mentioned task is solved in a third aspect of the present invention by a method for manufacturing a moulded part, comprising the steps of
i) providing a metal-polymer laminate structure (1) according to any of claims 1 to 8,
ii) processing the metal-polymer laminate structure (1) by at least one of a plastic metal working technique and
iii) obtaining the moulded part with a metal-polymer laminate structure.

By means of the present invention, an enhanced metal-polymer laminate structure (1) is provided as a multi-layer sandwich which ensures a triggered heat isolation as well as an active burn-through protection.

The metal-polymer laminate (1) can be processed in the same way as monolithic steel tapes, namely via forming by deep drawing, reshaping or punching. The assembly can be done by screwing, welding and the like. Compared to existing solutions in which expanded graphite is only integrated in a polymer matrix, the invented metal-polymer laminates (1) have the advantage that they have a certain mechanical stability even after the intumescent material, e.g. expanded graphite, has expanded. Thus, the structural stability of the respective component made of the metal-polymer laminate (1) is retained even in the event of fire. If the intumescent material, e.g. expanded graphite, was only embedded in a polymer, this polymer would pyrolyse/carbonise from about 400° C. such that finally a fragile structure of the expanded intumescent material, e.g. expanded graphite, and pyrolysed polymer remains, which no longer has any mechanical stability. A punctual strong/abrasive flame which can occur for instance in case of a thermal runaway of the battery modules can simply “blow away” such a fragile layer.

The invention is described in detail below.

If features are mentioned in the following description of the metal-polymer hybrid part and/or the laminate component (1) according to the invention, they also refer to the method according to the invention as described herein. Likewise, features which are mentioned in the description of the method according to the invention also refer to the metal-polymer hybrid part and/or the laminate component (1) according to the invention.

In a first aspect, the present invention relates to a metal-polymer laminate structure (1), comprising
a metallic layer (101),
at least one polymeric layer (103) provided on the metallic layer (101) and
a backing layer (105) provided on the at least one polymeric layer (103),

wherein the at least one polymeric layer (103) comprises an intumescent material.

The metallic layer (101) is arranged to face the heat source like a flame. It is preferred for the metal layer (101) to have a thickness of 0.1 mm to 2 mm. As the metal of the metallic layer (101), steel, galvanised (hot-dip or electroplated) steel, aluminium, zinc, tin, copper, chrome, magnesium or alloys thereof may be applied. Especially suitable are metals or alloys with a melting point<900° C., especially aluminium and zinc.

In particular, the metallic layer (101) may be pre-treated with an adhesion promoter/primer based on polyacrylates or polymethacrylates, polyvinyl amines, phosphoric acids, polyphosphoric acid; copolymers of maleic acid and acrylic acid and/or methacrylic acids and/or ester of acrylic or methacrylic esters, copolymers of maleic and styrene, copolymers of ethylene and acrylic acid and/or methacrylic acids and/or esters of acrylic or methacrylic esters and/or maleic acid and polyvinylpyrrolidone, to ensure good bonding to the at least one polymeric layer (103) and/or a first functional layer (107). The adhesion promoter is typically applied as aqueous solution via roll coating.

The at least one polymeric layer (103) is provided on the metallic layer (101) which is to be understood in the sense of the present invention that those layers ((101), (103)) are preferably completely and tightly in contact with each other.

The backing layer (105) is provided on the at least one polymeric layer (103) on the opposite side of the metallic layer (101). In other words, the metallic layer (101) and the backing layer (105) are sandwiching the at least one polymeric layer (103).

The at least one polymeric layer (103) comprises as its particular feature an intumescent material.

The expression “intumescent material” relates according to the present invention to a material that swells or expands as a result of heat exposure. This swelling or expanding leads to an increase in volume and decrease in density. In the present invention, the intumescent material serves for absorbing at least in part the heat of the heat source.

The metal-polymer laminate structure (1) according to the present invention exhibits an excellent flame protection to any component which is located on the rear side of the backing layer (105).

As will be shown in the examples according to the present invention, in case of a severe heat/flame exposure the metallic layer (101) may melt or burn-through locally, while the intumescent material comprised in the at least one polymeric layer (103) starts intumescing and thereby squeezing out of the opening in the metallic layer (101). While intumescing and squeezing out of the metallic layer (101), the intumescent material serves for an effective heat isolation of the backing layer (105), which in turn protects any component on the rear side of the backing layer (105) against the high temperatures of the heat source.

The insulating effect results from the intumescent material, e.g. expanded graphite, which repeatedly foams from the surface into the damaged area and renews the intumescent material layer, e.g. expanded graphite layer, damaged by the flame. The backing layer (105) has above all a structural function.

In order to enhance the joint between the metallic layer (101) and the at least one polymeric layer (103), therebetween a first functional layer (107) is interposed which in particular serves as a bonding layer.

According to the present invention, the first functional layer (107) is the tool to obtain a substance-locking connection between the at least one polymeric layer (103) and the metallic layer (101), otherwise the metal-polymer laminate structure (1) would not survive forming and deep drawing.

The term “substance-locking” describes a joint in which the joining partners are held together by atomic forces or molecular forces. At the same time, substance-locking joints can only be separated by destroying the joint itself. Substance-locking joints can be attained for instance by soldering, welding, gluing or vulcanising.

In particular, the first functional layer (107) is an unreinforced polymer, which is particularly suitable for creating good adhesion to the metal surface of the metallic layer (101) due to its chemical structure (polyamide). Because the first functional layer (107) is highly elastic, tensions during forming between the at least one polymeric layer (103) and the metallic layer (101) and/or the backing layer (105) can be compensated. In addition, stresses resulting from the different thermal expansion coefficients of the metallic layer (101) and/or the backing layer (105) and the at least one polymeric layer (103) can be absorbed.

In a particular embodiment of the invented metal-polymer laminate structure (1), the polymer of the at least one polymeric layer (103) comprises at least one of polyamide, polyvinylchloride, thermoplastic polyurethane, polyethylene, copolymers of polyethylene and α-polyolefins, copolymers of polyethylene and acrylic acid derivatives, polypropylene, polyurethane, melamine formaldehyde resins, polybutylene terephthalate, polyethylene terephthalate, polyoxymethylene, ethylene-vinyl acetate. In particular applied are low melting polyamides (melting point<200° C.) like PA12 and PA6/6.36, polyether block polyamides such as copolymerisates of polyether diamines and aliphatic dicarboxylic acids (C₄-C₄₀) and/or lactams (C₆-C₁₂) like caprolactam or lauryllactam, copolymerisates of aliphatic diamines (C₄-C₁₀) and aliphatic dicarboxylic acids (C₄-C₄₀), polycondensates of lactams (C₆-C₁₂), copolymerisates of lactams and/or aliphatic dicarboxylic acids and aliphatic diamines or combinations thereof.

In particular, as the polymer of the at least one polymeric layer (103) polyamide is preferred, in particular in the form of polyamide (PA6/6.36, PA6/66, PA6, PA12, PA6.10, PA6.12, polyether block polyamides).

In addition, the polymeric layer (103) may comprise phosphorous-containing flame retardants selected from the group consisting of organic phosphate, red phosphorus, ammonium polyphosphate, ammonium phosphate, ammonium dihydrogen phosphate or melamine cyanurate, aluminium hydroxide, magnesium hydroxide and mixtures thereof.

In a further development of the invented metal-polymer laminate structure (1), the first functional layer (107) is a thermoplastic layer which comprises polyamide, thermoplastic polyurethane, hotmelts or combinations thereof.

The first functional layer (107) is preferably thermoplastic and compatible with the metal surface of the metallic layer (101). It has a melting point or softening point of <250° C. The materials used are preferably polyamide (especially PA6, PA6/6.36, PA6/66, PA12, PA6.12, PA6.10, PA61/6T, copolymers of caprolactam or lauryllactam), thermoplastic polyurethane (TPU), and hotmelts and polyether block copolyamides.

The expression “hotmelts”, as used herein, is to be understood as designating solvent-free or water-free products which are more or less solid at room temperature, which are present in the hot state as a viscous liquid and are applied to the adhesive surface. On cooling they solidify reversibly and produce a firm bond. This group of adhesives are thermoplastic polymers based on different chemical raw materials. The main polymers used for these physically setting hot melt adhesives are polyamide resins, saturated polyesters, ethylene-vinyl acetate (EVA) copolymers, polyolefins, block copolymers (styrene-butadiene-styrene or styrene-isoprene-styrene) and polyimides. Polyamides, polyesters and polyimides are used in so-called high-performance hot-melt adhesives, while ethylene-vinyl acetate copolymers and polyolefins in so-called mass-melt adhesives.

The first functional layer (107) can also contain other functional additives such as plasticizers or functional polymers such as maleic anhydride grafted copolymers of polyethylene and α-polyolefins or MA grafted copolymers of polyethylene and acrylic acid esters.

According to the present invention it can be useful to increase the toughness and elasticity of the first functional layer (107) with the above-mentioned additives so that it can be better formed/deep-drawn in the metal-polymer laminate structure (1) and is not damaged.

From the viewpoint of mechanical stability, it is particularly preferred for the invented metal-polymer laminate structure (1) when the metallic layer (101) is in substance-locking contact with at least one polymeric layer (103).

It is also preferred in another development when between the at least one polymeric layer (103) and the backing layer (105) a backing functional layer (109) is interposed which in turn serves for a substance-locking contact between both layers.

It is furthermore preferred when the intumescent material comprises at least one of thermally expandable graphite, ammonium polyphosphate, sodium silicate-hydrate or combinations thereof.

Expandable graphite is particularly preferred since it does not absorb water or humidity from the surrounding.

In an embodiment of the invented metal-polymer laminate structure (1) the backing layer (105) is either a second metal layer or a thermoplastic polymer layer.

Since the heat isolation of the metallic layer (101) in conjunction with the at least one polymeric layer (103) is sufficient, the backing layer (105) does not need to be a metallic layer. Depending on the use of the invented metal-polymer laminate structure (1) a thermoplastic polymer layer for instance in view of lightweight construction, moldability and/or ability of joining may be applicable. On the other hand, in case of need for an enhanced mechanical stability the backing layer (105) can be embodied as a second metal layer. Such a second metal layer is useful when the metal-polymer laminate structure (1) is to be reshaped or deep-drawn.

Due to the enhanced joint and at least substance-locking contact between the metal layer (101), the at least one polymeric layer (103) and the backing layer (105) the invented metal-laminate polymer structure (1) is processable by plastic metal working techniques like for instance deep drawing and the like. In order to enhance such plastic metal working techniques additional friction reducing layers may be provided on either sides of the polymer laminate structure (1).

In another further development of the present invention, an additional functional layer (e.g. a third functional layer (1003)) may be provided on the outside of the backing layer (105), this is the backing layer (105) is covered on its both sides by functional layers, for instance before preparing the invented metal-polymer laminate structure (1).

Such an additional functional layer opens the possibility to add further elements on the outside of the backing layer (105), which may be strengthening/reinforcing ribs or further functionalities as will be described below in more detail.

In second aspect of the present invention, the above-mentioned task is solved by a method for preparing a metal-polymer laminate structure (1), in particular as detailed above, comprising the steps of
a) providing a metallic layer (101),
b) providing at least one polymeric layer (103) onto the metallic layer (101),
c) providing a backing layer (105) onto the at least one polymeric layer (103), thereby attaining a pre-laminate structure,
d) pressing the pre-laminate structure at elevated temperature and
e) obtaining the metal-polymer laminate structure (1).

The inventive method has the advantage that a metal-polymer laminate structure (1) as described above can be obtained which exhibits the advantageous properties as detailed in the foregoing description.

The providing of the at least one polymeric layer (103) onto the metallic layer (101) in step b) may be executed in different ways. On the one hand, a readymade polymeric layer (103) may be disposed onto the metallic layer (101), while in another alternative, the at least one polymeric layer (103) may be provided for instance by an extrusion process in situ.

The pressing of the pre-laminate structure in step d) takes place at an elevated temperature which, however, is below the temperature at which the intumescent material starts intumescing. Depending on the specific materials of the at least one polymeric layer (103) the temperature, the pressure and the time for pressing in step b) are to be adjusted.

Finally, in step e) the inventive metal-polymer laminate structure (1) is obtained.

In a further development of the invented method a further step aa) is comprised in which a first functional layer (107) is provided on the surface of the metallic layer (101) before step b) is carried out, this is before the at least one polymeric layer (103) is provided onto the metallic layer (101).

In an embodiment of this further development, an additional step cc) may be comprised wherein a functional backing layer (109) is provided on the surface of the backing layer (105) before carrying out step c) this is before providing the backing layer (105) onto the at least one polymeric layer (103).

Another further development of the invented method is that step d) is carried out at a temperature at which the intumescent material starts intumescing. In other words, the temperature is adjusted such that the intumescent material is swelling or expanding only a little just to an extend that the intumescent material particles are pressed into the metallic layer (101) and/or into the first functional layer (107) as well as the intumescent material particles are pressed into the backing layer (105) or into the backing functional layer (109). This pressing of the intumescent material particles into the adjacent layers serves for further enhancing at least substance-locking contact between the layers.

A third aspect of the present invention relates to a method for manufacturing a moulded part comprising the steps of
i) providing a metal-polymer laminate structure (1) according to the present invention as detailed above,
ii) processing the metal-polymer laminate structure (1) by at least one of a plastic metal working technique and
iii) obtaining the moulded part with a metal-polymer laminate structure.

By means of this invented method, moulded parts for a triggered heat isolation as well as an active burn-through protection can be tailor-made in any shape which is producible by plastic metal working technique.

It is particularly preferred, when the plastic metal working technique includes deep-drawing.

Following the above-mentioned step iii) preferably two options for a further processing can be applied. The first option is joining with another separately produced polymeric component by, for instance, as laser welding. The second option is using the metal-polymer laminate structure (1) as an insert in an injection moulding process.

Further aspects of the present invention are related to the use of the invented metal-polymer laminate structure (1), on the one hand as an active thermal shield for battery housings and on the other hand for triggered heat isolation and/or active burn-through protection.

Moreover, the metal-polymer laminate structure (1) according to the invention may be used as insert for injection moulding for instance by overmoulding the invented metal-polymer laminate structure (1) or by insert/outsert moulding thereof.

Finally, a very specific aspect of the present invention refers to a composite component (1000), comprising
a metal-polymer laminate structure (1) according to the present invention and as detailed above,
a polymeric foam layer (1005) provided on the backing layer (105), said backing layer (105) being covered by at least one third functional layer (1003),
a second solid layer (1009) having a density of more than 1000 g/l, which is covered by at least one fourth functional layer (1007), the at least one fourth functional layer (1007) being in contact with the polymeric foam layer (103),

wherein the polymeric foam layer (1005) has a density of 20 g/l to less than 1000 g/l.

In other words, the invented metal-polymer laminate structure (1) is added by another functionality, namely an energy absorbing ability.

In order to attain this additional functionality, the polymeric foam layer (1005) is provided which is joined to the backing layer (105) and the second solid layer (1009). respectively, by the third and fourth functional layers (1003, 1007). These third and fourth functional layers (1003, 1007) comprise an unreinforced polymer, which is particularly suitable for creating good adhesion to the surface of the backing layer (105) and the second solid layer (1009) due to the chemical structure (polyamide). Because the third and fourth functional layers (1003, 1007) are highly elastic, tensions during forming or bending between the polymeric foam layer (1005) and the backing layer (105) as well as the second solid layer (1009) can be compensated. In addition, stresses resulting from the different thermal expansion coefficients of the backing layer (105) as well as the second solid layer (1009) and the polymeric foam layer (1003) can be absorbed.

This specific aspect gives rise to the advantageous effect that well-known stiff construction materials as backing layer (105) and the second solid layer (1009) (like steel, aluminium, reinforced plastic) can be thermally joined with the polymeric foam layer (1003) in order to result in the specific construction material.

In addition to a triggered heat isolation as well as an active burn-through protection, this specific aspect furthermore assures an energy-absorbing ability. Thus, a combined heat isolation and energy-absorbing crash protection element can be provided.

Further aims, features, advantages and possible applications result from the following description of preferred embodiments not restricting the invention by means of the figures. All described and/or pictorially depicted features, on their own or in any combination, form the subject matter of the invention, even independently of their summary in the claims or their retrospective relationship. In the Figures

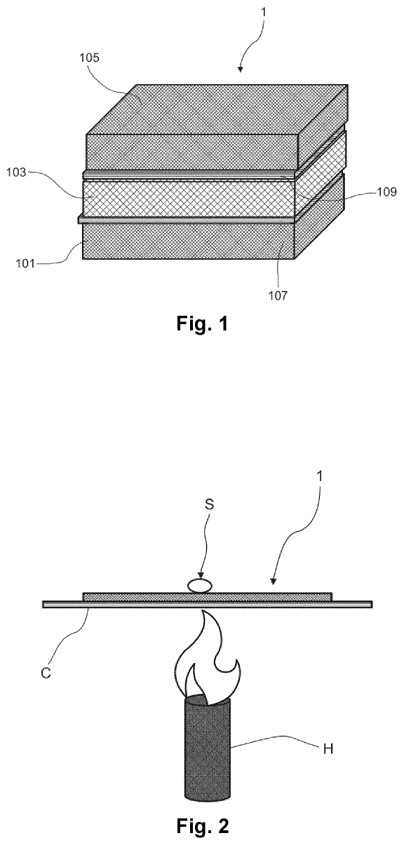

FIG. 1 depicts a schematic view of the metal-polymer laminate structure 1 according to an embodiment of the invention,

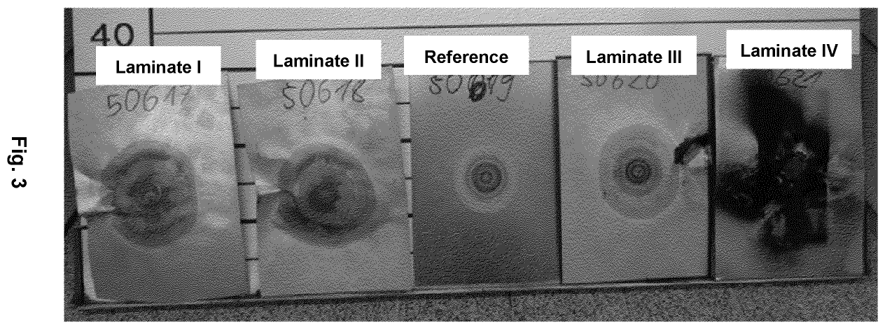

FIG. 2 depicts a laboratory set-up for testing the invented metal-polymer laminate structure 1,

FIG. 3 is a picture of comparative examples, a reference and inventive examples of the experiments,

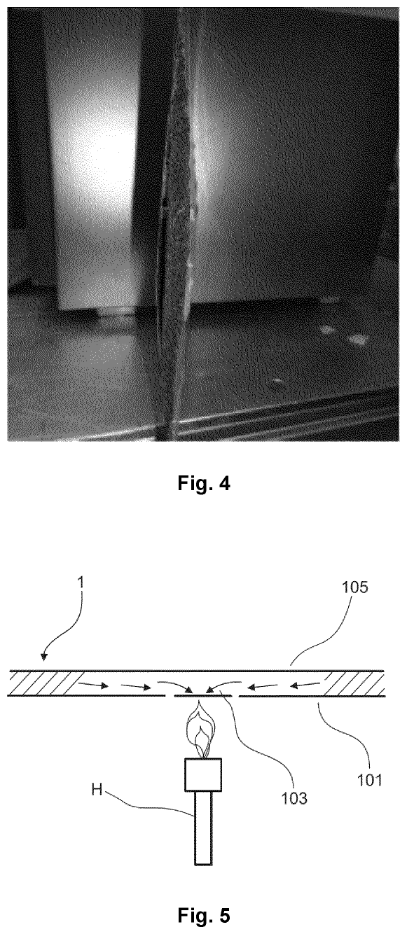

FIG. 4 is a picture of a cross-section of a metal-polymer laminate structure 1 according to the present invention,

FIG. 5 shows a schematic drawing of a burn-through experiment and

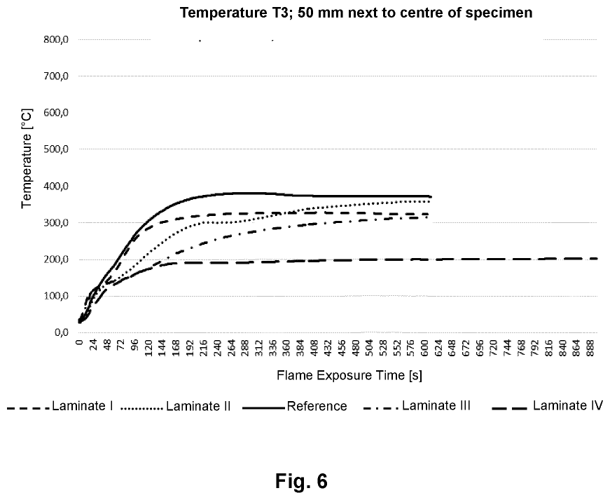

FIG. 6 shows a graph of a temperature development vs. duration of flame exposure.

In FIG. 1 a schematic overview of the metal-polymer laminate structure 1 according to the present invention in a particular embodiment is given. Starting from below, a metallic layer 101 is depicted on which a first functional layer 107 is provided in order to enhance the joint between the metal layer 101 and the polymeric layer 103. On top of the structure a backing layer 105 is shown which also comprises a functional backing layer 109 in order to enhance the joint between the backing layer 105 and the polymeric layer 103.

As mentioned above, the backing layer 105 may be a thermoplastic polymer layer or a second metallic layer. In case of a thermoplastic polymer layer the functional backing layer 109 can be omitted.

In FIG. 2 a scheme of a laboratory set-up for a flaming test is given, wherein below a heat source H is shown. On top of a carrier C the invented metal-polymer laminate structure 1 is arranged. What is not shown is an aperture within the carrier C on which the invented metal-polymer laminate structure 1 is arranged in order to allow the flame of the heat source H to directly expose the invented metal-polymer laminate structure 1. On top of the metal-polymer laminate structure 1 a sensor S is arranged in order to monitor the temperature on the rear side of the invented metal-polymer laminate structure 1, this is on the opposite side of the flame of the heat source H.

In FIG. 3 comparative examples, a reference and inventive examples and are shown which are described in more detail below. Laminate I and laminate II are comparative examples with common and commercially available shielding laminate materials. The reference is a simple steel plate. Laminate III and laminate IV are two specific embodiments of the invented metal-polymer laminate structure (1).

In FIG. 4 a cross-section picture of laminate IV as a particular embodiment of the metal-polymer laminate structure 1 according to the invention is shown. From this picture the intumesced polymeric layer 103 can be observed which although it has expanded, does not extraordinarily deform the metallic layer 101 and the backing layer 105 (here a second metallic layer).

In FIG. 5 a particular feature of the present invention is shown. Below again the heat source H is depicted. While flaming the metal-polymer laminate structure 1 according to this particular embodiment, the metallic layer 101 is burned-through such that the polymeric layer 103 containing the intumescent material is directly exposed against the flame. Due to this heat exposure the intumescing material starts intumescing and swells out of the burned-through hole of the metallic layer 101. Due to a more or less continuous swelling of the intumescing material through this hole, most of the heat is absorbed such that the temperature at the backing layer 105, this is on the rear side of the metal-polymer laminate structure 1, can be kept relatively low.

Additional effects are observed in that by the expansion of the polymeric layer 103 in case of fire the heat transfer through the metal-polymer laminate structure 1 is remarkably reduced. Moreover, by the local burn-through of the metal layer 101 and the activation of the intumescent material, a reduction of pressure is caused by foaming from the surface towards the flame.

This has the particular advantages of no increase or undefined deformation of the invented metal-polymer laminate structure 1 in the event of fire. A prevention of completely burning through is prevented by the continuous swelling/foaming of the intumescent material in the direction of the flame/local damage.

In FIG. 6 a graph of the temperature development of the examples, the reference and the comparative examples during exposure to the flame is shown. The upper curve is a normal steel plate of 0.8 mm in thickness. After a few seconds the temperature on the rear side is between 600° C. and 700° C. Laminate I and laminate II are prepared from common and commercially available shielding materials, wherein different thicknesses of 0.8 mm and 1.6 mm are prepared. During the flame exposure, depending on the thickness, the temperature of approximately 400° C. for the 0.8 mm laminate I and a temperature of approximately 380° C. for the 1.6 mm laminate II are observed at the rear side. What can be observed during the test is that while intumescing the middle layer of the laminate I and laminate II specimen, the metal layers on both sides thereof are extremely deformed such that the whole part is no longer fulfilling its housing function.

On the other hand, laminate III and laminate IV as two particular embodiments of the present invention show the lowest temperature profiles at the rear side of the invented metal-polymer laminate structure 1 wherein laminate 4 keeps the temperature at the rear side below 250° C.

Therefore, both examples according to the present invention do not necessarily require a second metallic layer as the backing layer (105) but also a thermoplastic polymeric layer can be applied.

Experiments

Production of the invented metal-polymer laminate structureₛ

The polymers listed in Table 1 were compounded with a ZE 25A UXTI twin-screw extruder in the quantities shown in Table 1 to form cylindrical pellets of certain polymer compositions (PC). Then films were extruded from the resulting pellets (PC1 and PC2). The films have the thickness defined in Table 2 and a width of 40 cm. The quantities given in Tables 1 and 2 are each in weight-%. The expanded graphite contained in sheet 4 was obtained directly from Wolman (Exterdens FD, 1 mm).
P1: polyamide 6 (Ultramid B24N from BASF SE)
P2: PA6/6.36 (Ultramid Flex F29 from BASF SE)
Co1: Lucalene A2540 D (Basell); ethylene/butyl acrylate copolymer
Co2: Exxelor 1801 (Exxon Chemicals) maleic anhydride grafted ethylene/propylene copolymer
Co3: ethylene/carboxylic acid copolymer (Luwax EAS 5 from BASF SE)
A1: Irganox B 1171 2×20KG 4G
A2: Talcum

TABLE 1
polymer compositions

| | | PZ1 | PZ2 |
|---|---|---|---|
| P1 | [wt.-%] | 59.1 | |
| P2 | [wt.-%] | | 86.1 |
| Co1 | [wt.-%] | 25 | |
| Co2 | [wt.-%] | 15 | 10 |
| A1 | [wt.-%] | 0.5 | 0.5 |
| A2 | [wt.-%] | 0.4 | 0.4 |

TABLE 2
sheets used

| | | | | | sheet 4 |
|---|---|---|---|---|---|
| | | sheet 1 | sheet 2 | sheet 3 | (Exterdens FD) |
| PZ 1 | [wt.-%] | 100 | 100 | | |
| PZ 2 | [wt.-%] | | | 100 | |
| R1 | [wt.-%] | | | | |
| sheet | | 1000 | 400 | 400 | 1000 |
| thickness | | | | | |
| [μm] | | | | | |

The sheets described in Table 2 are then consolidated with pretreated metal tapes in a heatable press to form the invented metal-polymer laminate structures. Metal tape and sheet are cut to the following dimensions: 300 mm×200 mm. The temperatures given in Table 3 were used. The sheets 1, 2 and 3 were pre-dried overnight with dry air at 80° C. First of all, scrims are produced, which are placed in the cold press together with a spacer in the respective target thickness. The press is closed with a contact pressure of 100 kN and heated to the target temperature given in Table 3. The temperature is held for 60 s, then the press is cooled to 50° C. and the laminate is removed.

The following metal tapes were used
M1: Galvanized steel pre-treated with Gardobond X4543 (aqueous solution of phosphoric acid and acrylic acid solution, tradename of Chemetal GmbH), thickness 250 μm
M2: aluminium tape pre-treated with Gardobond X4595 (aqueous solution of phosphoric acid and acrylic acid solution, tradename of Chemetal GmbH), thickness 300 μm

TABLE 3
invented metal-polymer laminate structures obtained

| | | | | | | lamination | overall |
|---|---|---|---|---|---|---|---|
| | | | | | | temperature | thickness after |
| | ply 1 | ply 2 | ply 3 | ply 4 | ply 4 | [° C.] | pressing [mm] |
| laminate I | M1 | sheet 1 | M1 | | | 250 | 800 |
| laminate II | M1 | sheet 2 | M1 | | | 250 | 2000 |
| laminate III | M1 | sheet 3 | sheet 4 | sheet 3 | M1 | 200 | 2200 |
| laminate IV | M2 | sheet 3 | sheet 4 | sheet 3 | M1 | 200 | 1600 |

The invented metal-polymer laminate structures 1 obtained were subjected to a flame test. The invented metal-polymer laminate structures were flame treated on the front side (from below as shown in FIG. 2) with a Bunsen burner and the temperature on the rear side was measured with two thermal sensors. The temperature versus flame exposure time is plotted as an evaluation in FIG. 6. A galvanized body steel tape with a thickness of 0.8 mm serves as the reference)

The metal-polymer laminate structures embodied as laminates I, II, Ill, IV showed a strongly reduced heat transmission compared to the reference. The metal-polymer laminate structures 1 containing expanded graphite showed the lowest heat transmission. The metal-polymer laminate structures embodied as laminates I+II deform strongly during the flame treatment. The metal-polymer laminate structure 1 embodied as laminate IV4 showed an interesting property: The metal layer burned through at the point of the flame treatment, which means that no pressure could build up in this metal-polymer laminate structure 1 which would lead to deformation. The expanded graphite in the polymeric layer 103 expanded during the flame treatment and prevented the passage of heat. Partially expanded graphite emerged at the flame point from which it was immediately replaced by expanded graphite reprinted from the inside of the laminate.

### REFERENCE SIGNS

1 metal-polymer laminate structure
101 metallic layer
103 polymeric layer
105 backing layer
107 first functional layer
109 backing functional layer
1000 composite component
1003 third functional layer
1005 polymeric foam layer
1007 fourth functional layer
1009 second solid layer
C carrier
H heat source
S sensor

1. A metal-polymer laminate structure, comprising
a metallic layer,
at least one polymeric layer provided on the metallic layer, and
a backing layer provided on the at least one polymeric layer,
wherein the at least one polymeric layer comprises an intumescent material,
wherein a first functional layer is interposed between the metallic layer and the at least one polymeric layer, and
wherein the first functional layer is a thermoplastic layer which comprises a material selected from the group consisting of polyamide, thermoplastic polyurethane, hotmelts, preferably polyamides such as PA6, PA6/6.36, PA6/66, PA12, PA6.12, PA6.10, PA6I/6T, copolymers of caprolactam or lauryllactam, thermoplastic polyurethane, and polyether block co-polyamides or combinations thereof.

2. The metal-polymer laminate structure according to claim 1, wherein the polymer of the at least one polymeric layer comprises at least one material selected from the group consisting of polyamide, polyvinylchloride, thermoplastic polyurethane, polyethylene, copolymers of polyethylene and α-polyolefins, copolymers of polyethylene and acrylic acid derivatives, polypropylene, polyurethane, melamine formaldehyde resins, polybutylene terephthalate, polyethylene terephthalate, polyoxymethylene, ethylene-vinyl acetate, low melting polyamides, PA12, PA6/6.36, polyether block polyamides, copolymerisates of polyether diamines and aliphatic dicarboxylic acids and/or lactams, copolymerisates of polyether diamines and aliphatic dicarboxylic acids and/or caprolactam, copolymerisates of polyether diamines and aliphatic dicarboxylic acids and/or lauryllactam, copolymerisates of aliphatic diamines and aliphatic dicarboxylic acids, polycondensates of lactams, copolymerisates of lactams and/or aliphatic dicarboxylic acids, and aliphatic diamines or combinations thereof.

3. The metal-polymer laminate structure according to claim 1, wherein the metallic layer is in substance-locking contact with the at least one polymeric layer.

4. The metal-polymer laminate structure according to claim 1, wherein the intumescent material comprises at least one material selected from the group consisting of thermally expandable graphite, ammonium polyphosphate, sodium silicate-hydrate, and combinations thereof.

5. The metal-polymer laminate structure according to claim 1, wherein the backing layer is a second metal layer or a thermoplastic polymer layer.

6. The metal-polymer laminate structure according to claim 1, wherein the metal-polymer laminate structure is processable by plastic metal working techniques.

7. A method for preparing a metal-polymer laminate structure according to claim 1, comprising the steps of
a) providing a metallic layer,
aa) providing a first functional layer on the surface of the metallic layer before carrying out step b,
b) providing at least one polymeric layer onto the metallic layer,
c) providing a backing layer onto the at least one polymeric layer, thereby attaining a pre-laminate structure,
d) pressing the pre-laminate structure at elevated temperature, and
e) obtaining the metal-polymer laminate structure.

8. The method according to claim 7, wherein step d) is carried out at a temperature at which the intumescent material starts intumescing.

9. The method for manufacturing a moulded part, comprising the steps of
i) providing a metal-polymer laminate structure according to claim 1,
ii) processing the metal-polymer laminate structure by at least one of a plastic metal working technique, and
iii) obtaining the moulded part with a metal-polymer laminate structure.

10. The method according to claim 9, wherein the plastic metal working technique includes deep-drawing.

11. A method of using a metal-polymer laminate structure according to claim 1 as an active thermoshield for battery housings and/or for triggered heat isolation and/or for active burn-through protection.

12. A composite component, comprising
a metal-polymer laminate structure according to claim 1,
a polymeric foam layer provided on the backing layer, said backing layer being covered by at least one third functional layer, and
a second solid layer having a density of more than 1000 g/l, which is covered by at least one fourth functional layer, the at least one fourth functional layer being in contact with the polymeric foam layer,
wherein the polymeric foam layer has a density of 20 g/l to less than 1000 g/l.

13-15. (canceled)
